(19) United States
(12) Patent Application Publication
(10) Pub. No.: US 2024/0104520 A1
(43) Pub. Date: Mar. 28, 2024

(54) INDUSTRIAL SECURITY USING BLOCKCHAIN OR NFTs

(71) Applicant: Rockwell Automation Technologies, Inc., Mayfield Heights, OH (US)

(72) Inventors: Kenneth W. Batcher, Hudson, OH (US); Sharath Chander Reddy Baddam, Twinsburg, OH (US); Juergen K. Weinhofer, Chagrin, OH (US); Timothy S. Biernat, Franklin, WI (US); David A. Vasko, Hartland, WI (US)

(21) Appl. No.: 17/936,142

(22) Filed: Sep. 28, 2022

(51) Int. Cl. G06Q 20/06; G06Q 20/40; G06Q 20/42

(52) U.S. Cl. CPC G06Q 20/065; G06Q 20/401; G06Q 20/42

(57) ABSTRACT

Industrial security using blockchain or NFTs (e.g., using a computerized tool) is enabled. For example, an industrial system can comprise: a memory that stores executable components, and a processor, operatively coupled to the memory, that executes the executable components, the executable components comprising a minting component that mints a non-fungible token associated with a product generated using industrial automation equipment, wherein the non-fungible token comprises a first verification element, and a verification component that: verifies the product based on a comparison of a first aspect of the product to the first verification element, and generates an output representative of the comparison.

### BACKGROUND

The subject matter disclosed herein relates generally to industrial automation systems and, more particularly, industrial security using blockchain or NFTs.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

According to an embodiment, an industrial system can comprise: a memory that stores executable components, and a processor, operatively coupled to the memory, that executes the executable components, the executable components comprising: a minting component that mints a non-fungible token associated with a product generated using industrial automation equipment, wherein the non-fungible token comprises a first verification element, and a verification component that: verifies the product based on a comparison of a first aspect of the product to the first verification element, and generates an output representative of the comparison.

In another embodiment, a method can comprise: prior to a disablement of an industrial automation device, determining, by an industrial automation system comprising a processor, configuration data representative of a configuration of the industrial automation device, storing, by the industrial automation system, a hash of the configuration data to an industrial blockchain, in response to an enablement of the industrial automation device, subsequent to the disablement, determining, by the industrial automation system, whether current configuration data representative of a current configuration of the industrial automation device matches the configuration data, and generating, by the industrial automation system, an output indicative of whether the current configuration data representative of a current configuration of the industrial automation device matches the configuration data.

In yet another embodiment, a non-transitory computer-readable medium can have stored thereon instructions that, in response to execution, cause an industrial device comprising a processor to perform operations, the operations comprising: writing, to an industrial blockchain, data representative of installation of a component in a product generated using industrial automation equipment, in response to receiving a verification request comprising data representative of components currently installed in the product, determining whether the component has been removed from the product based on a comparison of the components currently installed in the product with the component, and sending data representative of a result of the verification request.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment in accordance with one or more embodiments described herein.

FIG. 2 is a block diagram of an exemplary system in accordance with one or more embodiments described herein.

FIG. 3 is a block diagram of an exemplary controller in accordance with one or more embodiments described herein.

FIG. 4 is a diagram illustrating segregation of private and public NFT and/or blockchain information in an example industrial blockchain ecosystem in accordance with one or more embodiments described herein.

FIG. 5 is a diagram illustrating generation of blockchain data within a plant intranet in accordance with one or more embodiments described herein.

FIG. 6 is a block flow diagram of a process associated with industrial security in accordance with one or more embodiments described herein.

FIG. 7 is a block flow diagram of a process associated with industrial security in accordance with one or more embodiments described herein.

FIG. 8 is a block flow diagram of a process associated with industrial security in accordance with one or more embodiments described herein.

FIG. 9 is a generalized high-level diagram illustrating the relationship between blockchain technology and applications that can leverage blockchains in accordance with one or more embodiments described herein.

FIG. 10 is a graphic illustrating a centralized model for accessing and modifying data in accordance with one or more embodiments described herein.

FIG. 11 is a graphic illustrating a decentralized model for accessing and modifying data in accordance with one or more embodiments described herein.

FIG. 12 is a graphic illustrating an example blockchain architecture in accordance with one or more embodiments described herein.

FIG. 13 is a diagram illustrating a general architecture of a blockchain in accordance with one or more embodiments described herein.

FIG. 14 is a diagram illustrating a generalized architecture of an example blockchain platform in accordance with one or more embodiments described herein.

FIG. 15 is a generalized diagram illustrating creation of blocks and validation of blocks via consensus-based validation in accordance with one or more embodiments described herein.

FIG. 16 is a generalized diagram illustrating implementation of smart contracts within a blockchain-driven system in accordance with one or more embodiments described herein.

FIG. 17 is a high-level overview of entities and enterprises within an industrial supply and distribution chain within which industrial-specific blockchains can be utilized in accordance with one or more embodiments described herein.

FIG. 18 is an example computing environment in accordance with one or more embodiments described herein.

FIG. 19 is an example networking environment in accordance with one or more embodiments described herein.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that can comprise a number of devices, components, modules, and the like. It is to be understood and appreciated that the various systems can comprise additional devices, components, modules, etc. and/or may not include all of the devices, components, modules etc. discussed in connection with the figures. A combination of these approaches also can be used.

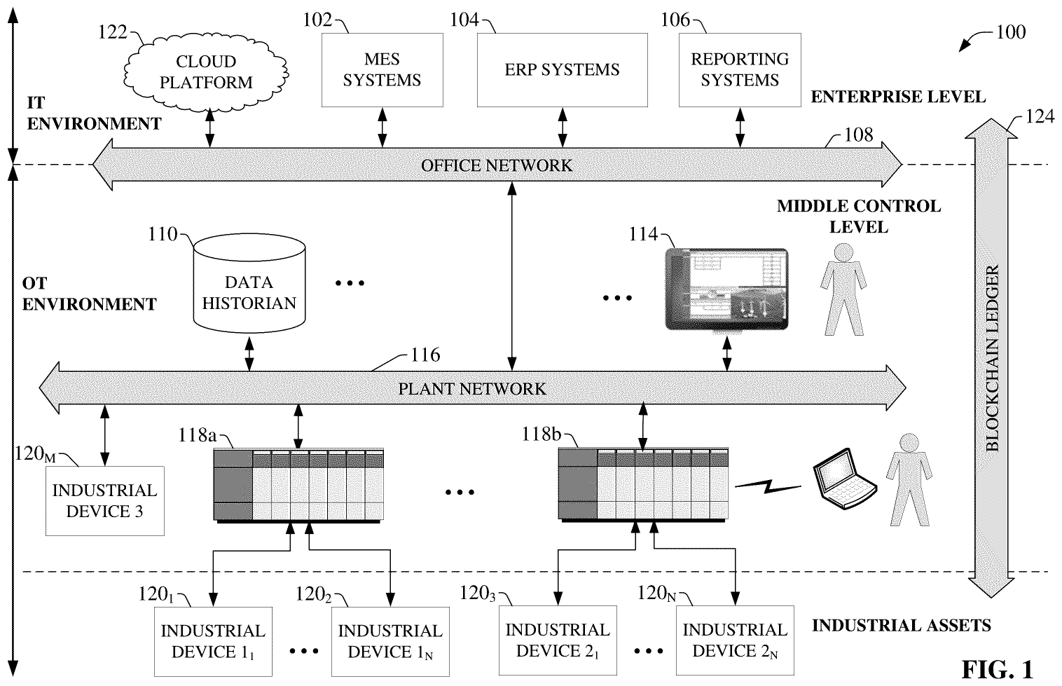

FIG. 1 is a block diagram of an example industrial environment 100. In this example, a number of industrial controllers 118 (e.g., industrial automation devices, equipment, systems, etc.) can be deployed throughout an industrial plant environment (e.g., to monitor and control respective industrial systems or processes relating to product manufacture, machining, motion control, batch processing, material handling, or other suitable industrial functions). In various embodiments, industrial controllers 118 can execute respective control programs to facilitate monitoring and control of industrial devices 120 making up the controlled industrial assets or systems (e.g., industrial machines). One or more industrial controllers 118 can additionally, or alternatively, comprise a soft controller (e.g., executed on a personal computer, on a server blade, or other hardware platform, or on a cloud platform). Some hybrid devices can additionally, or alternatively, combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, structured text, C++, Python, JavaScript, etc.

In one or more embodiments, industrial devices 120 can comprise input devices that provide data relating to the controlled industrial systems to the industrial controllers 118, output devices that respond to control signals generated by the industrial controllers 118 to control aspects of the industrial systems, and/or devices that act as both input and output devices. Exemplary input devices can comprise telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and/or other suitable telemetry devices. Output devices can comprise motor drives, pneumatic actuators, signaling devices, robot control inputs, valves, and/or other suitable output devices. Some industrial devices, such as industrial device 120M, can operate autonomously on the plant network 116 (e.g., without being controlled by an industrial controller 118).

In various implementations, industrial controllers 118 can communicatively interface with industrial devices 120 over hardwired connections or over wired or wireless networks. For example, industrial controllers 118 can be equipped with native hardwired inputs and outputs (e.g., that communicate with the industrial devices 120 to effect control of the devices). The native controller I/O can comprise digital I/O that transmits and receives discrete voltage signals to and from the field devices and/or analog I/O that transmits and receives analog voltage or current signals to and from the devices. The controller I/O can communicate with a controller's processor over a backplane (e.g., such that the digital and analog signals can be read into and controlled by the control programs). Industrial controllers 118 can additionally, or alternatively, communicate with industrial devices 120 over the plant network 116 using, for instance, a communication module or an integrated networking port. Exemplary networks can comprise the Internet, intranets, Ethernet, EtherNet/IP, DeviceNet, ControlNet, Data Highway and Data Highway Plus (DH/DH+), Remote I/O, Fieldbus, Modbus, Profibus, wireless networks, serial protocols, and the like. The industrial controllers 118 can additionally, or alternatively, store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices (e.g., including but not limited to motor drives, instruments, or condition monitoring modules) can store data values that are used for control and/or to visualize states of operation. Such devices can additionally, or alternatively, capture time-series data or events on a log for later retrieval and viewing.

Industrial automation systems herein can comprise one or more human-machine interfaces (HMIs) 114 that can enable plant personnel to view telemetry and status data associated with the automation systems and/or to control some aspects of system operation. HMIs 114 can communicate with one or more of the industrial controllers 118 over a plant network 116, and/or exchange data with the industrial controllers to facilitate visualization of information relating to the controlled industrial processes on one or more pre-developed operator interface screens. HMIs 114 can additionally, or alternatively, be configured to enable operators to submit data to specified data tags or memory addresses of the industrial controllers 118, thereby providing a means for operators to issue commands to the controlled systems (e.g., cycle start commands, device actuation commands, etc.) to modify setpoint values, etc. HMIs 114 can generate one or more display screens through which the operator interacts with the industrial controllers 118, and thereby with the controlled processes and/or systems. Exemplary display screens of one or more embodiments herein can visualize present states of industrial systems or their associated devices using graphical representations of the processes that display metered or calculated values, employ color or position animations based on state, render alarm notifications, and/or employ other such techniques for presenting relevant data to the operator. Data presented in this manner can be read from industrial controllers 118 by HMIs 114 and presented on one or more of the display screens according to display formats chosen by the HMI developer. HMIs can comprise fixed location or mobile devices with either user-installed or pre-installed operating systems, and either user-installed or pre-installed graphical application software.

Some industrial environments can additionally, or alternatively, comprise other suitable systems or devices relating to specific aspects of the controlled industrial systems. For example, one or more data historians 110 can aggregate and/or store production information collected from the industrial controllers 118 and other industrial devices.

Industrial devices 120, industrial controllers 118, HMIs 114, associated controlled industrial assets, and/or other plant-floor systems such as data historians 110, vision systems, and/or other suitable systems can operate on the operational technology (OT) level of the industrial environment. Higher level analytic and reporting systems can operate at the higher enterprise level of the industrial environment in the information technology (IT) domain (e.g., on an office network 108 or on a cloud platform 122). Such higher-level systems can comprise, for instance, enterprise resource planning (ERP) systems 104 that can integrate and/or collectively manage high-level business operations, such as finance, sales, order management, marketing, human resources, and/or other such business functions. Manufacturing Execution Systems (MES) 102 can monitor and manage control operations on the control level given higher-level business considerations. Reporting systems 106 can collect operational data from industrial devices on the plant floor and generate daily and/or shift reports that summarize operational statistics of the controlled industrial assets. One or more components, devices, systems, etc. of the industrial environment 100 can be configured to utilize or interface with the blockchain ledger 124 (e.g., an immutable blockchain ledger).

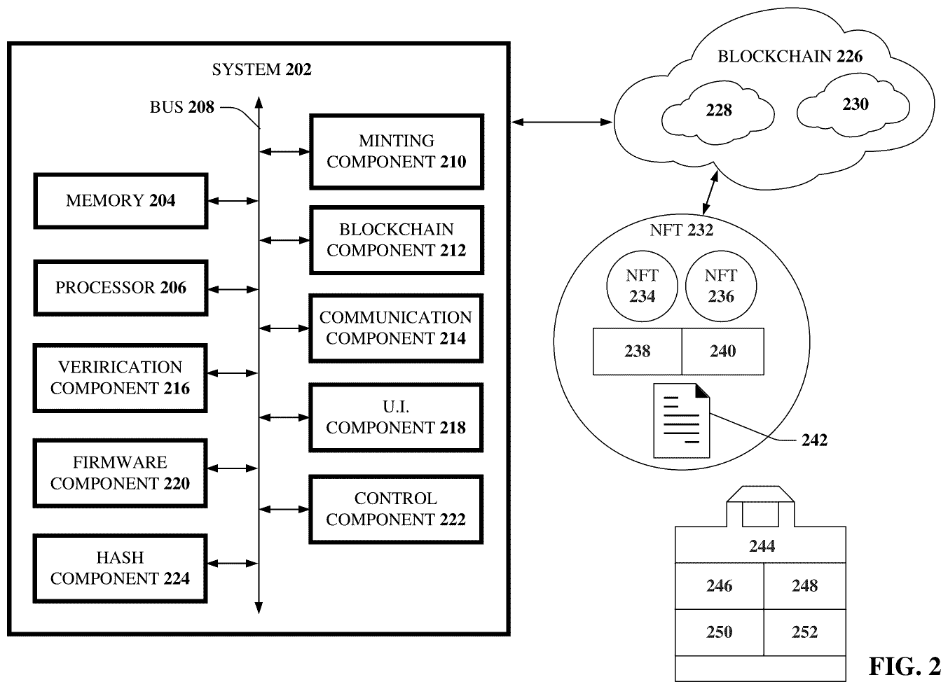

FIG. 2 illustrates an example, non-limiting blockchain enabled industrial system 202 in accordance with one or more embodiments herein. System 202 can comprise a computerized tool, which can be configured to perform various operations relating to industrial security. The system 202 can comprise one or more of a variety of components, such as memory 204, processor 206, bus 208, minting component 210, blockchain component 212, communication component 214, verification component 216, user interface (U.I.) component 218, firmware component 220, control component 222, and/or hash component 224. In various embodiments, the system 202 can be communicatively coupled to, or can further comprise, blockchain ledger 226 and/or non-fungible token (NFT) 232. In various embodiments, one or more of the memory 204, processor 206, bus 208, minting component 210, blockchain component 212, communication component 214, verification component 216, user interface (U.I.) component 218, firmware component 220, control component 222, hash component 224, blockchain ledger 226 and/or NFT 232 can be communicatively or operably coupled (e.g., over a bus or wireless network) to one another to perform one or more functions of the system 202. In various embodiments, the system 202 can comprise a programmable logic controller (PLC), programmable automation controller (PAC), or other such device.

In various embodiments, the system 202 can embed one or more verification elements in given product at the time of manufacture which can be utilized to later distinguish the authentic product from a counterfeit product or a grey-market product. According to an embodiment, the minting component 210 can mint an NFT (e.g., NFT 234) associated with a product 244 that is generated using industrial automation equipment herein (e.g., industrial device(s) 120), such as industrial robots, automation devices, conveyors, coating application machines, etc. In this regard, the minting component 210 can mint a unique instance of the NFT 234 for a unique instance of the product 244. In various embodiments, the NFT 232 can comprise a plurality of verification elements such as a first verification element (e.g., verification element 238) and a second verification element (e.g., verification element 240), different from the first verification element.

Verification elements herein can comprise elements that help uniquely identify a respective product 244 (e.g., from another instance of a product 244 or distinguish from a counterfeit product). This approach can be used to counter grey market proliferation in which entities acquire used industrial automation equipment, clean the industrial automation equipment, replace non-functioning components of the industrial automation equipment until functioning industrial automation equipment exists, apply a new counterfeit barcode sticker(s) with a more recent manufacturing code and/or non-traceable barcode, and sell the equipment as new. For these reasons, among others, it is beneficial manufacturing entities and downstream entities or customers to have the ability to authenticate products using mechanisms that are difficult or impossible to defeat. In various embodiments, one of the verification elements (e.g., verification element 238 or another suitable verification element) can comprise a label unique to the product 244. Such a label can comprise a barcode, QR code, data matrix, or another suitable unique label code that can be applied to the product 244 (e.g., printed, adhered, etched, etc.)

When a first verification element comprises a label, a corresponding second verification element can comprise a position of the label on the product 244. For example, industrial automation equipment herein can apply the label in different locations on products 244 (e.g., with differences indistinguishable to the human eye) and record the exact location of the label on the product 244. In this regard, in addition to unique labels being applied to the product 244, a precise location of the label can be determined and stored using the NFT 232 for additional security. Labels can be intentionally provided with slight variance in position, so that the exact position of the barcode label on a product can serve as a verification element in addition to the data represented in the barcode label itself. This way, if a counterfeit product comprises a copy of a barcode (e.g., verification element 238), it will also need to be applied with hyper-precision (with respect to position) to match the original barcode label, else it would fail a check of the second verification element (e.g., verification element 240). Thus, the verification component 216 can verify the product 244 based on a comparison of a first aspect of the product to the first verification element and a second aspect of the product to the second verification element. In this regard, aspects can be applicable to verification elements. For example, the first verification element can comprise a known barcode as recorded via NFT 232, and the first aspect can comprise a barcode of a product purported to be an authentic instance of the product 244 and thus checked via the verification component 216. Likewise, the second verification element can comprise a known position of the barcode as recorded via NFT 232, and the second aspect can comprise a position of barcode of a product purported to be an authentic product 244 and thus checked via the verification component 216.

The verification component 216 can further generate an output representative of the comparison of the first aspect to the first verification element and/or the second aspect to the second verification element. In further embodiments, the second verification element can further comprise data associated with a plastic or cellophane seal on a bottle/product, or an ultra-precise weight of a bottle/product and/or its contents. Therefore, a second aspect herein can comprise data purported to match the data associated with the plastic or cellophane seal on a bottle/product or weight purported to match the weight of the bottle/product and/or its contents. In another example, the second verification element can comprise a time that the label was applied to the product 244 or a time at which the product 244 was manufactured or completed a defined step of manufacturing. In this regard, presentation of the second verification element can be required for complete verification/authentication along with the first verification element. In this example, the second verification element can be checked by comparing the second verification element with the second aspect received via the communication component 214 and/or U.I. component 218.

According to an embodiment, the communication component 214 can receive a request potentially applicable to the product 244 (e.g., from an external device or entity). For example, the request can be received from an end user entity, manufacturer entity, retailer entity, supplier entity, etc. The request can comprise an authenticity check of the product 244, for instance, to ensure that the product 244 is an authentic instance of the product 244 using the first aspect and the second aspect of a product received via the communication component 214 or determined via the system 202. The U.I. component 218 can then render the output representative of the comparison between aspects and verification elements via a client device (not depicted) or another suitable output medium and/or generate an alert in response to the aspects and the verification elements not matching. It is noted that the U.I. component 218 can render an output visually (e.g., on screen/display) or audibly and/or communicated to one or more external devices via the communication component 214. According to an embodiment, the U.I. component 218 can perform visualization functions similar to those of HMI 114, including rendering telemetry and/or status data associated with the system 202 and other systems or components herein. Further, the communication component 214 can send or receive data associated with the system 202 or other systems or components herein. For example, the communication component 214 can facilitate communication between the system 202, office network 108, plant network 116, blockchain ledger 124, and/or corresponding devices, systems, components, platforms, etc. In various embodiments, the U.I. component 218 can be configured to receive user input and to render output to the user in any suitable format (e.g., visual, audio, tactile, etc.). In some embodiments, U.I. component 218 can be configured to communicatively interface with a development application that executes on a client device (e.g., a laptop computer, tablet computer, smart phone, etc.) that is communicatively connected to the blockchain-enabled industrial device (e.g., via a hardwired or wireless connection). The U.I. component 218 can then receive user input data and render output data via the development application. In other embodiments, U.I. component 218 can be configured to generate and serve suitable graphical interface screens to a client device, and exchange data via these graphical interface screens. Input data that can be received via U.I. component 218 can include, but is not limited to, user-defined control programs or routines that include industrial blockchain instructions, blockchain configuration parameters (which may be provided as configuration parameters of the blockchain instructions), or other such data. In is additionally noted that the communication component 214 can comprise the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.)

As described, the NFT 232 can comprise various verification elements herein, associated with the product 242. In one or more embodiments, the blockchain component 212 can store the NFT 232 to an industrial blockchain 226. In other embodiments, the minting component 210 can directly store the NFT 232 to the industrial blockchain 226. It is noted that the NFT 232 can further comprise a birth certificate for the product 244. Such a birth certificate can comprise a serial number associated with the respective unique instance of the product 244, a bill of materials 242 for the product 244 (e.g., a list of components or raw materials in the product 244), country of origin of the product 244, energy usage or efficiency data associated with the manufacturing of the product 244, manufacturing information associated with the product 244, a part identifier (e.g., a VIN number of an assembled vehicle, a serial number of a capped and labeled bottle, etc.) a timestamp indicating a time of assembly or manufacture, measured quality metrics (e.g., leak test results, cap or bolt torque data, etc.), machine states or telemetric data at the time the product was assembled (e.g., oven temperatures, moisture levels, water or air pressures, etc.), or other suitable information that can be married to a unit or batch of product 244. In this regard, the verification component 216 can compare the birth certificate or the bill of materials 242 to materials of a product in order to verify authenticity of the product or item in question. In some embodiments, the product 244 can be configured to generate and send data representative of components currently installed in the product 244 to the system 202 (e.g., receivable via the communication component 214). In other embodiments, a user entity can submit a list of components currently installed in the product 244 (e.g., via the communication component 214 and/or U.I. component 218), and the verification component 216 can convert the list of components to the data representative of the components currently installed in the product 244 (e.g., using a defined algorithm).

To write to the blockchain 226 (e.g., by a controller, system, and/or component herein), a request can be broadcast by the blockchain component 212 or minting component 210 to some or all registered participants of the blockchain ledger 226. These participants can include other controllers, devices, systems, or nodes that are authorized to participate in the blockchain ecosystem. Every registered participant can check hashes against defined blockchain algorithms in order to validate the request to write to the blockchain 226. Using a defined proof of work algorithm, participants of the blockchain ledger 226 can determine validity of the new block(s). Validity of the new block(s) can be determined based upon the participants reaching a consensus or a defined threshold for agreement (e.g., according to a defined agreement criterion) for determining validity. If consensus or a defined agreement is reached, the new block(s) can be added to the blockchain ledger 226.

In one or more embodiments, the NFT 232 can comprise a group of non-fungible sub-tokens (e.g., NFT 234 and/or NFT 236). Such sub-tokens can be minted using the minting component 210 for components or subcomponents of the product 244. For example, the minting component 210 can mint the sub-token 234 for the component 246 and/or subcomponent 248 of the product 244. Likewise, the minting component 210 can mint the sub-token 236 for the component 250 and/or subcomponent 252 of the product 244. These sub-tokens can be minted (e.g., by the minting component 210) at various manufacturing stages of the product 244 or as components or subcomponents are installed in the product 244.

In various embodiments, a manufacturing entity or other entity can generate a firmware update for a product produced using industrial automation equipment herein. In some embodiments, the firmware component 220 can install a firmware update to the product 244 in response to the comparison by the verification component 216 resulting in a match of the first aspect of the product 244 to the first verification element and/or the second aspect of the product 244 to the second verification element. Further, the firmware component 220 can block installation of a firmware update to the product 244 in response to the comparison by the verification component 216 resulting in a non-match of the first aspect of the product 244 to the first verification element and/or a non-match of the second aspect of the product to the second verification element. In further embodiments, if a user is a legitimate customer, the user can be issued a customer-based token (e.g., an NFT minted by the minting component 210) that can be utilized to authenticate a firmware download (e.g., a future firmware download, subsequent to the generation of the corresponding NFT).

In another embodiment, the industrial blockchain 226 can be leveraged to ensure that an industrial automation device has not been modified or tampered with between states of the device, such as power states. In this regard, the control component 222 can, prior to disablement of an industrial automation device (e.g., industrial device 120), determine configuration data representative of a configuration (e.g., from a first point in time) of the industrial automation device. Such a configuration can comprise configuration parameters or hardware settings, permitted users or user roles that are permitted to access industrial automation software, identities of I/O modules or special function modules, limits or values, positions, dip switch settings, values of configuration parameters, control programming, a position of the industrial automation device (e.g., prior to disablement), or other suitable configuration information. The blockchain component 212 can then store the configuration data to the industrial blockchain 226 or a fingerprint or hash of the configuration data to the industrial blockchain 226. Such a fingerprint can be representative of configuration data and can be stored to the blockchain 226. In various implementations, such fingerprints can be generated using a defined hash or checksum algorithm applied to the configuration data. It is noted that the blockchain ledger 226 can capture sequence(s) of operations. In this regard, operations A,B,C can yield different results as compared to the same operations in order C,A,B. The foregoing principle can be utilized, for instance, by a system herein, to calibrate industrial automation equipment before generating products using the industrial automation equipment, thus enforcing that operations applied to a device were actually applied (e.g., upgraded, installed, etc.) in a correct order. In the event of a failure to validate a block chain query/request a system herein can return message (e.g., via a user interface of a system or controller herein) indicating the reason(s) that the failure occurred (e.g., cannot use feature X because user did not pay yearly membership fee and did not upgrade equipment to the latest revision of software).

In one or more embodiments, the verification component 216 can, in response to enablement of an industrial automation device, determine whether current configuration data (e.g., from a current time or a second point subsequent to the first point in time) representative of a current configuration of the industrial automation device matches the configuration data (e.g., from the time of prior disablement of the industrial automation device). Such enablement and disablement can correspond to a transition of the device to or from a device sleep mode or a transition between a power on state and a power off state. Next, the verification component 216 can generate an output indicative of whether the current configuration data representative of a current configuration of the industrial automation device matches the configuration data. It is noted that the communication component 214 and/or the U.I. component 218 can render the output representative of the comparison between the current configuration data and the configuration data via a client device (not depicted) or another suitable output medium. The U.I. component 218 can render an output visually (e.g., on screen/display) or audibly and/or communicated to one or more external devices via the communication component 214. In an embodiment, a configuration check can occur on device shutdown (e.g., saved to memory 204 and/or blockchain ledger 226) so that on device bootup, the same configuration can be restored. According to an example, a terminal position information for luggage conveyers at power-off or a sleep state can be saved to the industrial blockchain ledger 226 (e.g., to confirm proper boot-up). Therefore, the industrial blockchain ledger 226 can be utilized in order to query and compare (e.g., via the system 202) shutdown state and bootup state in order to determine if an event has occurred or a device (e.g., industrial device 120) has been moved/modified, or hacked. In various embodiments, the blockchain component 212 can (e.g., prior to the control component 222 determining whether current configuration data matches the configuration data) retrieve the configuration data from the industrial blockchain 226. In one or more embodiments, the control component 222 can, in response to a determination that the current configuration data does not match the configuration data, disable the industrial automation device.

In some embodiments, joint test action group (JTAG) identifier(s) of an industrial automation device (e.g., industrial device 120) can be stored on the industrial blockchain ledger 226. In this regard, the industrial automation device can execute a powerup self-test in which during a boot process, JTAG identifier(s) can be checked against the blockchain ledger 226 before completing the powerup self-test and/or permitting device bootup. Every JTAG ID on a board of a device can be queried and checked against the blockchain. Thus, in one or more embodiments, configuration data herein can comprise JTAG identifier applicable to the industrial automation device.

According to another embodiment, the system 202 can be utilized to determine whether a product was rebuilt or modified (e.g., by an unauthorized entity) based on a comparison of components currently installed in the product with components known to be installed in the product. This can help prevent grey-market proliferation of products herein. Thus, data representative of installation of authorized components can be stored to the industrial blockchain herein (e.g., via the blockchain component 212). Such data can comprise one or more unique identifiers associated with respective components of a given product. In this regard, the blockchain component 212 can write, to an industrial blockchain 226, data representative of installation of a first component (e.g., component 246), of a group of components (e.g., comprising component 246, component 250, etc.), in a product 244 manufactured using the blockchain-enabled industrial automation equipment described herein. Such data representative of installation can comprise one or more of an identity of a respective component, the type of the component, a serial number of the component, the date and time the component was added, the device, machine, or entity that installed the component, or other conditions or information applicable to the installation of the component. In some implementations, the blockchain component 212 can further write, to the industrial blockchain 226, data representative of installation of a second component (e.g., component 250), of the group of components, in the product 244. In order to verify a product, entity in possession of the product 244 (e.g., an end user entity, manufacturer entity, retailer entity, supplier entity, etc.) can request verification of one or more components of the product 244. In some embodiments, the product 244 can be configured to generate and send data representative of components currently installed in the product 244 to the system 202 (e.g., receivable via the communication component 214). In other embodiments, a user entity can submit a list of components currently installed in the product 244 (e.g., via the communication component 214 and/or U.I. component 218), and the verification component 216 can convert the list of components to the data representative of the components currently installed in the product 244 (e.g., using a defined algorithm). In some embodiments, the product 244 can be configured to generate and send data representative of components currently installed in the product 244 to the system 202 (e.g., receivable via the communication component 214). In other embodiments, a user entity can submit a list of components currently installed in the product 244 (e.g., via the communication component 214 and/or U.I. component 218), and the verification component 216 can convert the list of components to the data representative of the components currently installed in the product 244 (e.g., using a defined algorithm). The verification component 216 can, in response to receiving (e.g., via the communication component 214 or U.I. component 218) a verification request (e.g., from an entity in possession of the product 244) comprising data representative of components currently installed in the product 244 or determining the components installed in the product 244, determine whether the first component and/or the second component have been removed from the product 244 based on a comparison of the components currently installed in the product 244 with the first component and/or the second component (e.g., determining whether the first component and/or the second component are represented in the components installed in the product 244). The communication component 214 and/or U.I. component 218 can send data representative of a result of the verification request (e.g., to the requestor entity and/or to a defined recipient).

In some embodiments, the data representative of the installation of the first component and/or the data representative of the installation of the second component can be subjected to a defined hashing algorithm or defined checksum algorithm (e.g., via the hash component 224) prior to storage on a blockchain 226.

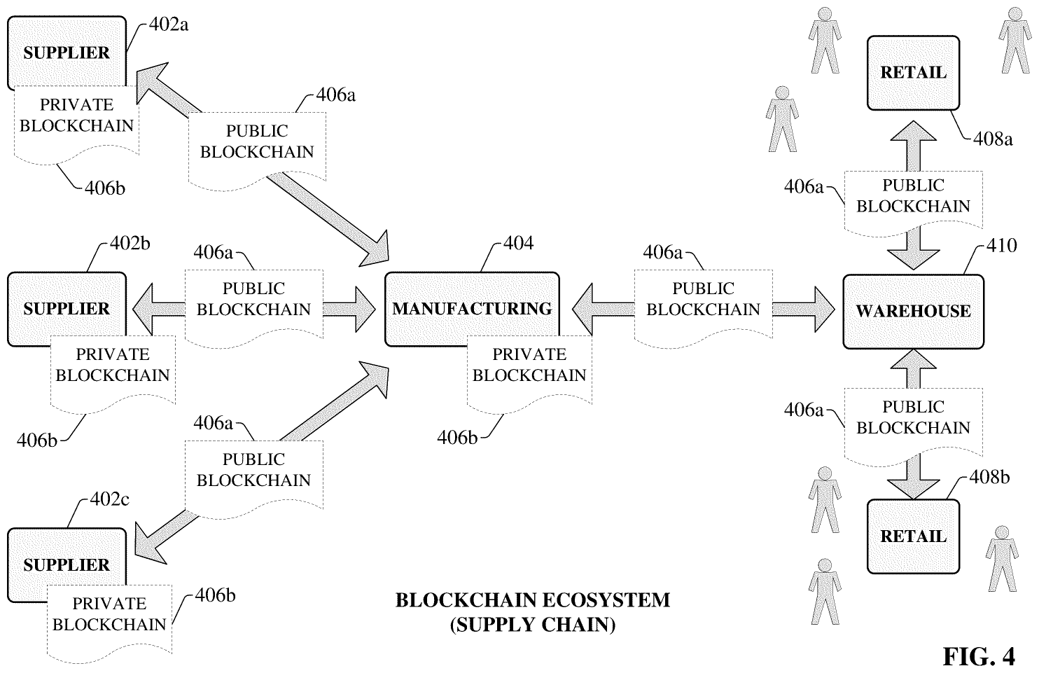

In various embodiments, blockchain 226 can be representative of one or more blockchains, public (e.g., public industrial blockchain 228) and/or private (e.g., private industrial blockchain 230). In some embodiments, the blockchain 226 can comprise the public industrial blockchain 228 and the private industrial blockchain 230 as an aggregate of a plurality of blockchains. In this regard, see FIG. 4 as later discussed in greater detail, in which public and/or private industrial blockchains can be used to track manufactured products through a manufacturing facility or across multiple facilities of an industrial enterprise.

To this and various other ends, it is noted that the supply, manufacturing, and distribution chain for a manufactured product extend well beyond the boundaries of a single industrial facility, and cross boundaries between several interconnected but substantially independent entities. For example, an industrial enterprise (which may comprise one or more manufacturing and warehouse facilities under a common ownership) may receive materials or component parts from one or more supplier entities that produce the materials or parts. The enterprise may also purchase industrial assets (e.g., custom-built machines, motor control cabinets, etc.) from one or more original equipment manufacturers (OEMs). Manufactured products are sold and distributed via retail outlets that may be owned and operated by entities who are independent from the industrial enterprise. While these independent entities may collect and track data generated within their own boundaries as participants in a common supply chain, these various entities may benefit from selective sharing of their collected data. Reliable and trusted sharing of data can be particularly crucial if business contracts between the entities are in place, since this shared information can ensure that the terms of the contracts are being satisfied. However, since each entity's data is typically collected and stored locally (or on protected remote storage, such as a proprietary cloud-based storage platform), shared data owned by one of the entities may not be easily and readily accessible by third parties, and trustworthiness of the shared data may be a concern.

During operation at the manufacturing entity's facility, the blockchain-enabled industrial system 202 can track a number of production statistics, including an accumulated number of operating cycles performed by the machine, an accumulated amount of time that the machine has run, a number of parts produced by the machine, etc. The system 202 and/or industrial devices of a machine's control cabinet can record this production data in the blockchain ledger 226. The control devices also record modifications made to the machine or its associated industrial devices by the manufacturing entity. For example, changes made to the firmware of the industrial controller or other control devices as a result of reimaging or patching are recorded in the public blockchain ledger, as are modifications made to the OEM-developed control program or application executed on the industrial controller.

In response to determining that information stored in the public ledger satisfies a criterion (e.g., a criterion defined in a smart contract) indicating that the OEM is contractually obliged to perform a component replacement or other maintenance action on the machine (e.g., in response to execution of a defined number of machine cycles, when the accumulated machine run time exceeds a defined number of operating hours, when the machine has produced a defined number of parts, etc.), the blockchain component 212 can sign, on behalf of the owner, a verifiable and contractually binding component replacement order as a transaction in the blockchain 226.

Since the OEM has access to data stored in the public blockchain, the OEM receives and verifies the component replacement order, and in response ships the necessary machine component to the manufacturing entity. The manufacturing entity installs the replacement component and records a signed conformation of the replacement in the public blockchain ledger. The OEM can use this verified transaction to initiate payment processing. Using this system, the replacement component, the vendor-specific device firmware, and the OEM-specific application are all verifiably tracked in the blockchain ledger 226. The current state reflected in the public blockchain can reflect the authorized production cycle count, which can be viewable by both the OEM and the end user. For subscription-based operation of the machine, the OEM can authorize the production cycle count in the public blockchain ledger based on payment and agreement. The end-user can also set the criteria for the machine to automatically renew additional production authorization at defined thresholds.

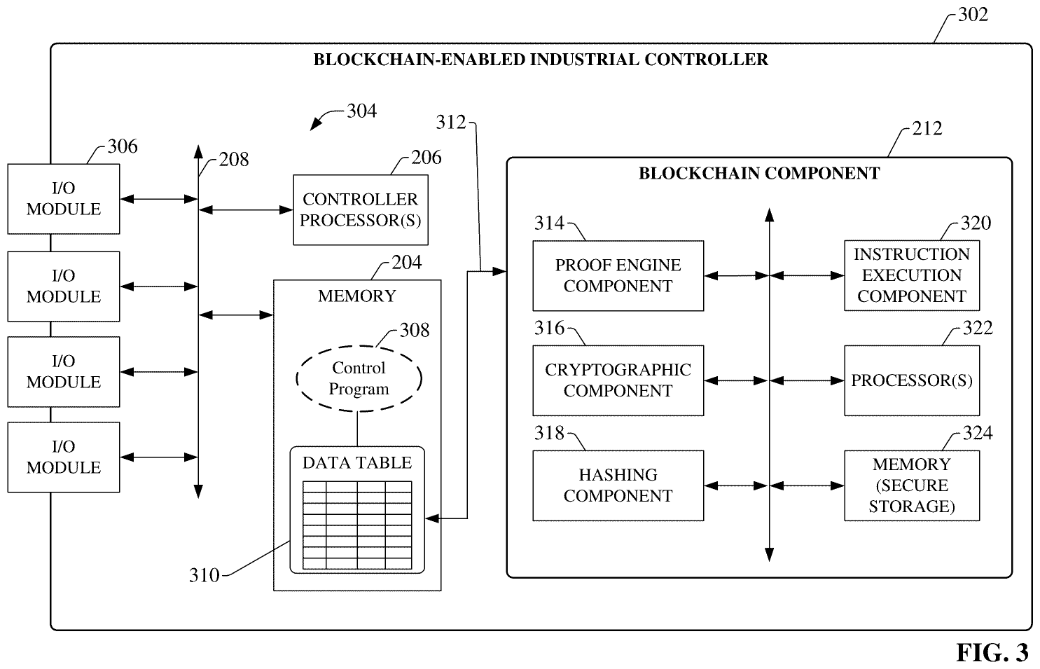

FIG. 3 is a diagram of the example blockchain-enabled industrial controller 302, illustrating that hardware and processing resources for carrying out industrial blockchain functions can be segregated from processing resources that carry out the controller's primary control functionality. It is noted that in some embodiments, the industrial system 202 can comprise the industrial controller 302. In other embodiments, the industrial system 202 can be communicatively coupled to the industrial controller 302 (e.g., over a BUS or wireless network). In this example architecture, control components 304 can include the memory 204 on which is stored the control program 308 executed by the controller 302 and the data table 310 that stores real-time values of the controller's digital and analog inputs and outputs, setpoint values, calculated values, or other data tag values. Control components 304 also include one or more I/O modules 306, which interface the controller 302 with input and output devices (not shown), such an industrial automation equipment, that make up a controlled industrial system or process. I/O modules 306 are communicatively connected to the controller's backplane or communication bus 208, and exchange data with the data table 310 via the backplane. I/O modules 306 can include input modules that measure aspects of the controlled system as digital and/or analog signals (e.g., 4-20 mA signals, 0-10 VDC signals, switched input voltages, etc.) and write these values to designated data tags or memory addresses of data table 310. I/O modules 306 can also include output modules that read digital or analog values from designated data tags or memory addresses of data table 310 and translate these values into output signals (e.g., switched outputs, 4-20 mA output signals, 0-10 VDC output signals, etc.) directed to output devices of the controlled system. One or more controller processors 206 or execution engines execute the control program 308 and control updating of data values in the data table 310 in accordance with measured data from the I/O modules 306 and execution of the control program 308.

In this illustrated example, the blockchain component 212 is embodied as a sub-system of controller 302, and is implemented using separate memory and processing resources from control components 304. For example, blockchain component 212 can utilize its own processor 322 and memory 324, which are separate from controller processor(s) 206 and memory 204. In this way, blockchain functions (e.g., transaction processing and validation, block generation, smart contract processing and enforcement, etc.) performed by the blockchain component 212 can be segregated from control-related analytics, and is not necessarily implemented using the primary control language of the controller 302. While components of the blockchain component 212 can read data from and write data to the controller's data table 310 (e.g., via a data bus 312) in connection with performing blockchain creation and management functions, the processing resources used to carry out these blockchain functions are physically separated from those used to carry out control. In this way, blockchain functions carried out by the blockchain component 212 do not impact performance of the controller's basic control functionality. As noted above, although FIG. 3 depicts the embedded blockchain component 212 as being a sub-system of the industrial controller 302, blockchain component 212 can also be embedded on other types of industrial devices, including but not limited to motor drives, industrial sensors, vision systems, safety relays, barcode stampers, or other such devices.

The blockchain component 212 can be utilized in virtually any type of data-generating industrial device, including but not limited to an industrial controller 302, a motor drive, an HMI terminal, a vision system, an industrial optical scanner, a meter, a telemetry device, an industrial safety device, a safety relay, a barcode stamper, an ERP server, an MES server, an industrial Internet of Things (IIoT) device, or other such device or system. The blockchain component 212 can comprise a proof engine component 314, a cryptographic component 316, a hashing component 318, an instruction execution component 320, one or more processors 322, and/or memory 324. In various embodiments, one or more of the proof engine component 314, cryptographic component 316, hashing component 318, instruction execution component 320, the one or more processors 322, and/or memory 324 can be electrically and/or communicatively coupled to one another to perform one or more of the functions of the blockchain component 212. In some embodiments, components 314, 316, 318, and/or 320, can comprise software instructions stored on memory 324 and executed by processor(s) 322.

Proof engine component 314 can be configured to validate industrial or supply chain transactions for inclusion in a new block of an industrial blockchain in accordance with a blockchain instruction. Cryptographic component 316 can be configured to encrypt and decrypt transaction data, recipe data, or other information exchanged with other blockchain-enabled industrial devices within a blockchain system or ecosystem. In some embodiments, cryptographic component 316 can leverage private keys and/or public keys in connection with encryption and decryption of blockchain information. Hashing component 318 can be configured to hash transaction data and generate Merkle trees in accordance with a blockchain instruction. Instruction execution component 320 can be configured to execute industrial blockchain instructions that create blocks representing transactions received or executed by the blockchain component 212, add the blocks to industrial blockchains, and/or update a blockchain ledger.

The one or more processors 322 can perform one or more of the functions described herein with reference to the systems and/or methods disclosed. Memory 324 can be a computer-readable storage medium storing computer-executable instructions and/or information for performing the functions described herein with reference to the systems and/or methods disclosed. As will be described in more detail below, processor(s) 322 and memory 324 may be segregated from the primary memory that performs the device's real-time control functions. It is noted that memory herein can be removable (e.g., a removable memory card, USB drive, etc.) For example, an industrial network may not comprise an open network for which a system herein can query a cloud network or server directly. Thus, such networks can comprise intranet networks exposed only to a plant floor, thus preventing exposure of the networks to the Internet and reducing risks of ransomware or secure hacks. Removable memory devices can thus be utilized in controllers herein to read/write data for a token herein and/or smart contract query of an industrial blockchain.

It is noted that various embodiments described herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

Systems and/or associated controllers, servers, or machine learning components described herein can comprise artificial intelligence component(s) which can employ an artificial intelligence (A.I.) model and/or M.L. or an M.L. model that can learn to perform the above or below described functions (e.g., via training using historical training data and/or feedback data).

In some embodiments, a system or controller herein can comprise an A.I. and/or M.L. model that can be trained (e.g., via supervised and/or unsupervised techniques) to perform the above or below-described functions using historical training data comprising various context conditions that correspond to various augmented network optimization operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by the system or controller. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, a system or controller herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the system or controller can perform a utility-based analysis that factors cost of initiating the above-described operations versus benefit. In this embodiment, the system or controller can use one or more additional context conditions to determine various thresholds herein.

To facilitate the above-described functions, a system or controller herein can perform classifications, correlations, inferences, and/or expressions associated with principles of artificial intelligence. For instance, the system or controller can employ an automatic classification system and/or an automatic classification. In one example, the system or controller herein can employ a probabilistic and/or statistical-based analysis (e.g., factoring into the analysis utilities and costs) to learn and/or generate inferences. The system or controller can employ any suitable machine-learning based techniques, statistical-based techniques and/or probabilistic-based techniques. For example, the M system or controller can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the system or controller herein can perform a set of machine-learning computations. For instance, the system or controller herein can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

FIG. 4 is a diagram illustrating segregation of private and public NFT and/or blockchain information in an example industrial blockchain ecosystem. The example ecosystem depicted in FIG. 4 comprises a number of blockchain systems associated with respective entities that participate in a manufacturing and distribution chain, including supplier entities 402, a manufacturing entity 404, a warehouse entity 410, and retail entities 408. Supplier entities 402 may be manufacturing entities that provide parts or materials to manufacturing entity 404 that manufactures a product using the provided parts or materials. One or more supplier entities 402 may be OEMs that provide custom-built machines to the manufacturing entity 404. Manufacturing entity 404 may provide finished products to a warehouse 410, which may be owned by the same industrial enterprise that owns the manufacturing entity 404. Warehouse 410 may distribute product to retail entities 408. It is to be appreciated that the example industrial ecosystem depicted in FIG. 4 is only intended to be exemplary, and that an industrial blockchain ecosystem can comprise any collection of entities of various roles. It is noted that any each stage in the industrial blockchain ecosystem represented in FIG. 4, NFTs can be minted by the supplier entities 402, manufacturing entity 404, warehouse entity 410, and/or retail entities 408 such that data captured in each manufacturing stage can be captured and stored in a public and/or private blockchain.

One or more of the blockchain systems that make up the ecosystem can maintain both private blockchains 406b for internal use as well as public blockchains 406a accessible to other participating entities in the blockchain ecosystem. Public and private industrial blockchains can be used within a blockchain ecosystem comprising several business entities of a supply chain for a variety of applications, including but not limited to tracking of machine performance and usage, tracking of products across a manufacturing facility or within a single industrial enterprise, tracking of products across the larger supply and distribution chain, distribution of proprietary recipe information, and product auditing. These example industrial blockchain applications are discussed in more detail below.

Blockchain-enabled industrial devices that support generation of public and private industrial blockchains can be used to track performance and usage of machines sold by OEMs to their customer manufacturing entities. In an example scenario, multiple machines built by different OEMs (e.g., one or more supplier entities 402) can be deployed to an end user manufacturing site (manufacturing entity 404). According to a vertical-specific example, manufacturing entity 404 may be a beverage factory that runs a bottling line comprising fillers, sealers, conveyors, cartoners, and other machines. Some of the machines that make up the bottling line may be built and provided by one or more OEMs. During the machine build, blockchain-enabled industrial devices herein at the OEMs can generate private blockchains 406b that record transactions and associated data associated with the machine building process (e.g., via NFTs) that are to be accessible only by authorized devices and personnel associated with the OEM. The OEM's blockchain-enabled industrial devices can also be configured to generate public blockchains 406a that record publicly shared transaction data (e.g., via respective NFTs) that can be accessed and viewed by other devices that participate in the blockchain ecosystem, including devices associated with the customer manufacturing entity 404. This publicly accessible information can include, for example, results of factory acceptance tests (FATs) performed on the machine prior to shipping to the customer. Blockchain-enabled industrial devices that make up the machine, as well as blockchain-enabled test equipment used by the OEM, can capture these FAT results as transactions and record the results as validated blocks in the machine's public blockchain, which is shared with blockchain node devices at the manufacturing facility.

In a related aspect, NFTs generated for the machine (by the blockchain-enabled devices that make up the machine as well as by other peripheral systems such as ERP and MES systems) can be leveraged to perform machine warranty and maintenance tracking. For example, NFTs herein can be minted in response to one or more various events being determined to have occurred, and can capture usage and repair information for the industrial automation equipment described herein. This information can include, for example, dates and times at which a maintenance operation was performed, identities of any components or devices that were replaced or reprogrammed, dates and times of lock out/tag out procedures that were followed in connection with a maintenance action, identities of the personnel who performed the maintenance action, etc. The NFT that records this maintenance information can be maintained on a blockchain via distributed devices within the manufacturing entity's plant intranet, such that any single device on the plant's blockchain network can query the blockchain to obtain maintenance log information for the machine. This creates a tamper-proof record of maintenance operations that can be accessed without the need to log into a data historian. Some of this maintenance and operational information can be maintained on a private blockchain that is only accessible by devices on the plant's own intranet. Additionally, blockchain-enabled devices within the plant can generate a public version of the machine's blockchain that includes warranty-related information that is accessible by outside support entities (e.g., OEMs or other technical support entities) who have a business interest in the information. Information in this public version of the blockchain can include, for example, operating hours, power cycles, identities of devices added to the machine (which may be unauthorized devices), etc. This public version of the machine's blockchain can be viewed by outside support entities to validate claims made by the machine owner regarding internal maintenance actions performed on the machine or the machine's operational history.

The techniques described above regarding the use of industrial blockchains to track an OEM-provided machine or a product across its lifecycle can also be applied to parts, sub-assemblies, or materials provided by supplier entities 402 to a manufacturing entity 404. For example, the blockchain systems that make up an example industrial blockchain ecosystem may be geographically distributed across multiple businesses that together form an integrated supply chain for a product. In an automotive example, sub-assemblies for a car produced by an automotive facility (the manufacturing entity 404 in this example) may be manufactured by respective sub-assembly suppliers (supplier entities 402). In addition to generating private blockchains 406b that record proprietary manufacturing data generated in connection with the fabrication of the sub-assemblies, blockchain-enabled industrial devices at the supplier entities 402 can generate public blockchains 406a that record information regarding manufacture of the sub-assemblies permitted to be shared with the manufacturing entity 404. These public blockchains 406a are accessible by devices at the manufacturing entity 404, and only comprise a subset of available sub-assembly manufacturing information that the supplier is contractually obligated to provide to the manufacturer. This public blockchain information can be incorporated into the manufacturer's own information tracking for the fully assembled and sold vehicles.

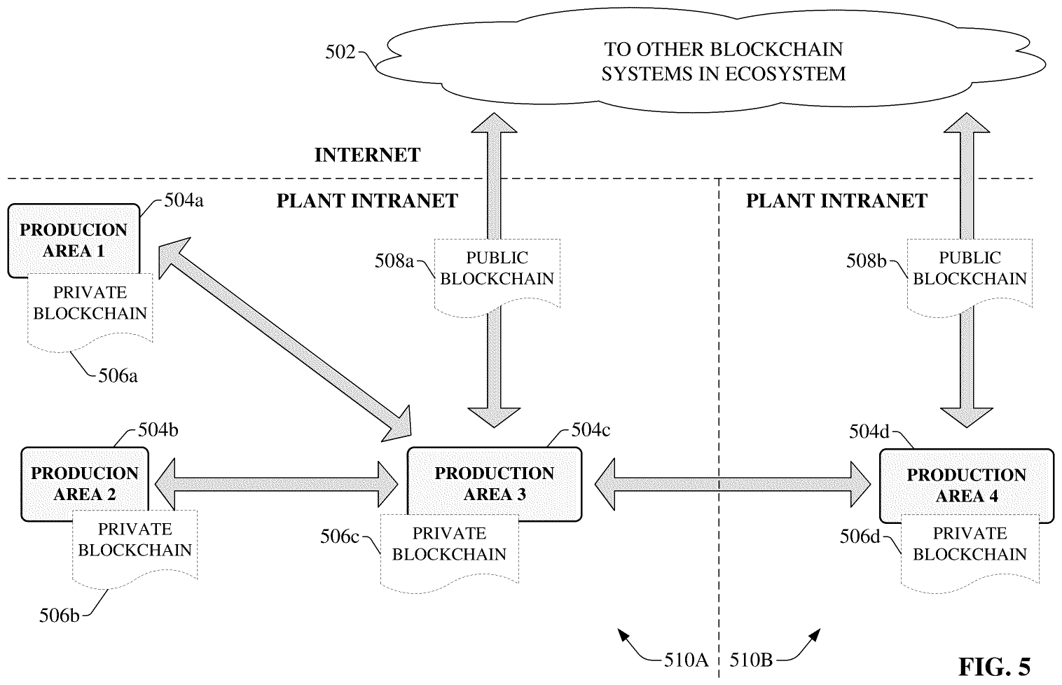

Public and/or private industrial blockchains can also be used to track manufactured products through a manufacturing facility or across multiple facilities of an industrial enterprise. FIG. 5 is a diagram illustrating generation of blockchain data within a plant intranet. The manufacturing facility depicted in FIG. 5 may correspond, for example, to manufacturing facility 510_{A}, 510_{B}, a combination of 510_{A} and 510_{B}, or one of the supplier entities 402 depicted in the supply chain ecosystem of FIG. 4. In FIG. 5, a number of production areas 504 within a manufacturing facility—including Production Area 1 and Production Area 2—produce component parts or materials that are provided to Production Area 3, which assembles the parts or materials received from those upstream production areas. During runtime, blockchain-enabled industrial devices herein (e.g., system 202, controller 302, industrial automation equipment, etc.) that operate within Production Areas 1 and 2 (the supplier production areas) bundle transactions generated within their respective production areas in connection with production of the component parts or materials, generate and validate NFTs representative of these transactions (e.g., collaboratively with other blockchain-enabled industrial devices within the respective production areas using consensus-based validation techniques such as practical byzantine fault tolerance, proof-of-work, or proof-of-state), and add the validated NFTs or blocks to a private blockchains 506 (e.g., 506a, 506b, 506c, 506d) that are only accessible to participating devices on the plant's intranet (and not to other entities of the larger blockchain ecosystem).

Component parts or materials produced by Production Areas 1 and 2 are conveyed to Production Area 3 for assembly into either a finalized product or a sub-assembly of the final product. The blockchain-enabled industrial controller 202 or system herein that controls the industrial assets in Production Area 3 can link, via a blockchain, the NFTs generated by controllers, devices, or equipment in Production Areas 1 and 2, which are associated with the respective component parts generated in those production areas. The devices of Production Area 3 can also expand this composite blockchain by associated NFTs and/or adding records of its own operations performed on the assembled product (e.g., via generation of further NFTs).

In some implementations, each assembled product can be represented by a unique NFT 232 minted for that respective product, with each NFTs transaction data comprising production statistics for the product 244. Example statistics that can be archived in the NFT can include, but are not limited to, a birth certificate (e.g., a serial number associated with the product 244), a bill of materials 242 for the product 244 (e.g., a list of components or raw materials in the product 244), a part identifier (e.g., a VIN number of an assembled vehicle, a serial number of a capped and labeled bottle, etc.), a timestamp indicating a time of assembly or manufacture, measured quality metrics (e.g., leak test results, cap or bolt torque data, etc.), machine states or telemetric data at the time the product was assembled (e.g., oven temperatures, moisture levels, water or air pressures, etc.), or other such information that can be married to a unit or batch of product. In one or more implementations, each operation performed on the unit of product during its progress through the production process can be represented in the unique NFT 232 associated with the respective instance of the product 244.

The technique for linking NFTs via industrial blockchains associated with component parts of a final assembled product can be extended to include parts, sub-assemblies, or materials received from outside supplier entities, and more generally to traversal of products across the entire supply chain (e.g., the supply chain depicted in FIG. 4). In such scenarios, supplier-provided components (e.g., batches of material, sub-assemblies, component parts, etc.) can be received at the manufacturing facility together with blockchains that record transactions associated with production of the components at the supplier sites and/or mint NFTs that capture events associated with a unique instance of a product 244. One or more blockchain-enabled industrial devices herein at the manufacturing facility can link these NFTs via an industrial blockchain herein, thus yielding a plurality of related NFTs generated during the production cycle of a unique product as the components of the product are assembled and/or processed. When the product leaves the manufacturing facility and arrives at the next entity in the supply chain (e.g., another manufacturing entity, a warehouse entity, a shipping entity, a retailer, etc.), any new transactions performed on the product at the next entity can be captured in an NFT and added to an existing blockchain associated with the product (including synchronized blockchain data associated with any of the product's sub-assemblies or component parts). In addition to manufacturing transactions, the industrial blockchain associated with the unit or instance of the product can also record product handling and location tracking information (e.g., warehouse shipping information) (e.g., captured via an NFT) as well as business-related information (e.g., order information, purchase information, authorized geolocation information, etc.). All of these diverse transactions are validated by a consortium of devices within the industrial blockchain system or ecosystem using suitable consensus-based validation techniques.

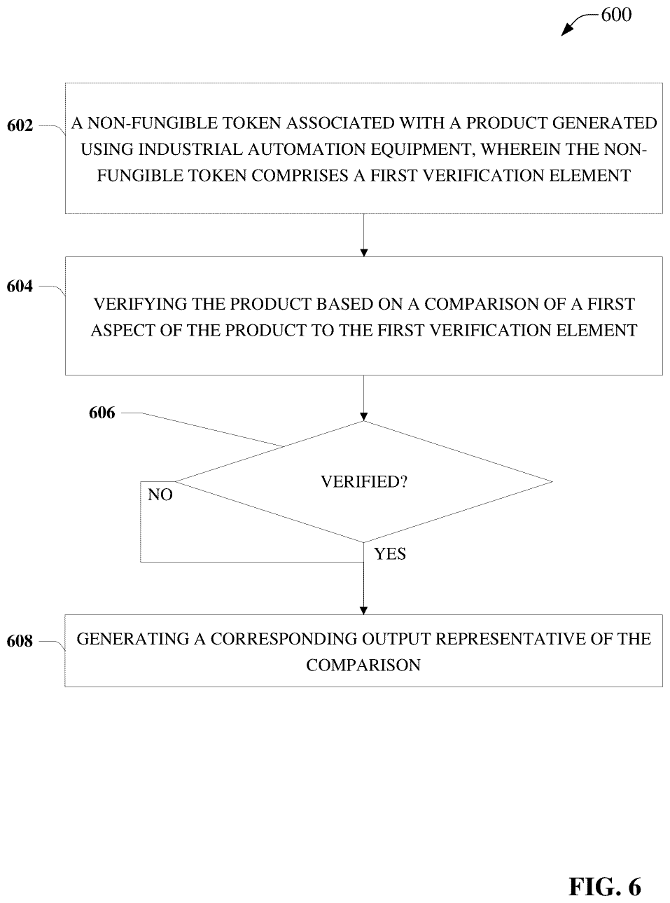

FIG. 6 is a block flow diagram of a process 600 for industrial security in accordance with one or more embodiments described herein. At 602, the minting component 210 can mint a non-fungible token (e.g., NFT 232) associated with a product (e.g., product 244) generated using industrial automation equipment (e.g., industrial device(s) 120), wherein the non-fungible token comprises a first verification element and/or a second verification element. Such verification elements can comprise elements that help uniquely identify a respective product 244 (e.g., from another instance of a product 244 or a counterfeit product). In this regard, a first verification element herein can comprise a label unique to the product 244. Such a label can comprise a barcode, QR code, data matrix, or another suitable unique label code that can be applied to the product 244 (e.g., printed, adhered, etched, etc. A second verification element herein can comprise a position of the label on the product 244, data associated with a plastic or cellophane seal on a bottle/product, an ultra-precise weight of a bottle/product and/or its contents, a time that the label was applied to the product 244 or a time at which the product 244 was manufactured or completed a defined step of manufacturing, or another suitable verification element. At 604, the verification component 216 can verify the product 244 based on a comparison of a first aspect (e.g., purported to match the first verification element) of the product 244 to the first verification element and/or a second aspect (e.g., purported to match the first verification element) of the product 244 to the second verification element. At 606, if a result of the comparison of the first aspect of the product to the first verification element and/or the second aspect of the product to the second verification element results in a match (e.g., verified) at 606 (e.g., Y at 606), the verification component 216 can generate an output representative of the comparison and resulting match at 608. If at 606, the result of the comparison of the first aspect of the product to the first verification element and/or the second aspect of the product to the second verification element results in a non-match (e.g., not verified) at 606 (e.g., N at 606), the verification component 216 can generate an output representative of the comparison and resulting non-match at 608.

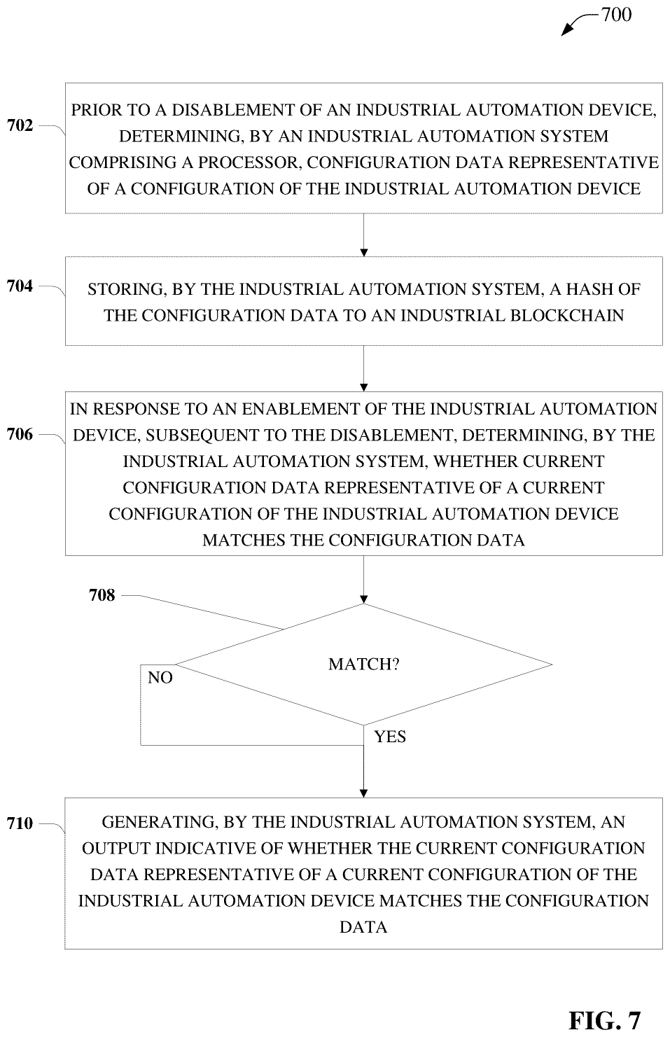

FIG. 7 is a block flow diagram of a process 700 for industrial security in accordance with one or more embodiments described herein. At 702, the control component 222 can, prior to disablement (e.g., entering a sleep state or a power-off state) of an industrial automation device (e.g., industrial device 120), determine configuration data representative of a configuration (e.g., from a first point in time) of the industrial automation device. Such a configuration can comprise configuration parameters or hardware settings, permitted users or user roles that are permitted to access industrial automation software, identities of I/O modules or special function modules, limits or values, positions, dip switch settings, values of configuration parameters, control programming, a position of the industrial automation device (e.g., prior to disablement), or other suitable configuration information. In other embodiments, a configuration fingerprint can be generated using a defined hash or checksum algorithm applied to the configuration data. At 704, the blockchain component 212 can store a hash of the configuration data to the industrial blockchain 226. At 706, the verification component 216 can, in response to enablement (e.g., exiting a sleep state or powering on) of the industrial automation device (e.g., via the control component 222), subsequent to the disablement, determine whether current configuration data representative of a current configuration of the industrial automation device matches the configuration data. At 708, if a result of the comparison of the current configuration data and the configuration data results in a match (e.g., Y at 708), the verification component 216 can generate an output representative of the comparison and resulting match at 710. If at 708, the result of the comparison of the current configuration data and the configuration data results in a non-match (e.g., N at 708), the verification component 216 can generate an output representative of the comparison and resulting non-match at 710. Further, if the result of the comparison of the current configuration data and the configuration data results in a non-match (e.g., change in configuration), the control component 222 can prevent the device from executing.

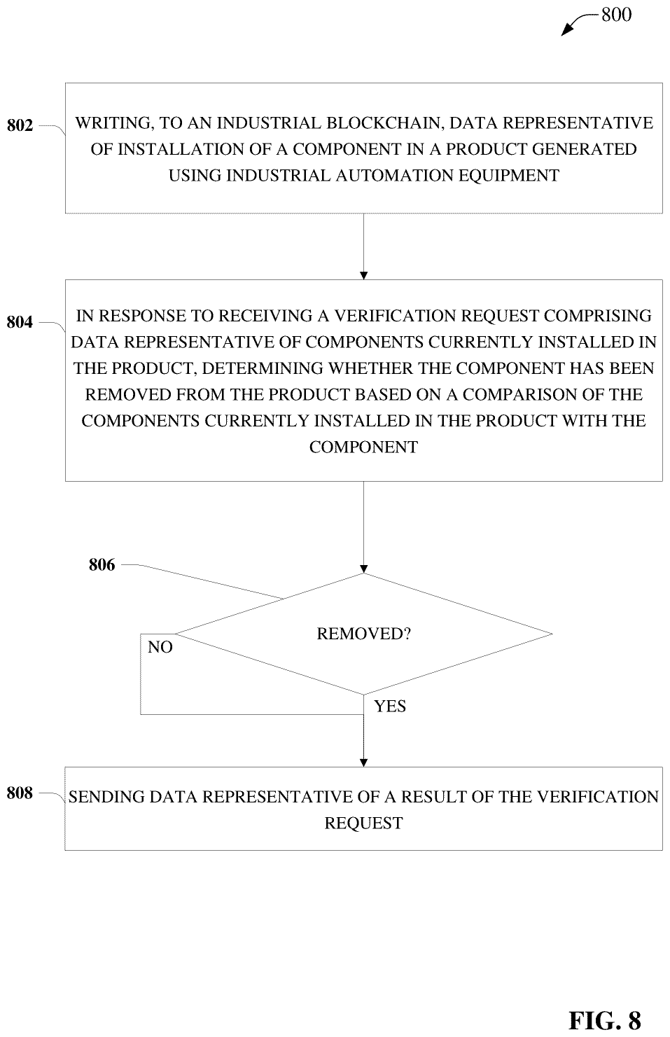

FIG. 8 is a block flow diagram of a process 800 for industrial security in accordance with one or more embodiments described herein. At 802, the blockchain component 212 can write, to an industrial blockchain 226, data representative of installation of a component (e.g., component 246) in a product 244 generated using industrial automation equipment herein (e.g., industrial device 120). Data representative of installation herein can comprise one or more of an identity of a respective component, the type of the component, a serial number of the component, the date and time the component was added, the device, machine, or entity that installed the component, or other conditions or information applicable to the installation of the component. At 804, the verification component 216 can, in response to receiving (e.g., via the communication component 214 or U.I. component 218) a verification request (e.g., from an entity in possession of the product 244) comprising data representative of components currently installed in the product 244, determine whether the component has been removed from the product 244 based on a comparison of the components currently installed in the product 244 with the component. At 806, if the verification component 216 determines that the component has been removed from the product 244, the communication component 214 and/or U.I. component 218 can then send data representative of a result of the verification request (e.g., component removed) (e.g., to the requestor entity and/or to a defined recipient) at 808. If at 806, the verification component 216 determines that the component has not been removed from the product 244, the communication component 214 and/or U.I. component 218 can then send data representative of a result of the verification request (e.g., component not removed) (e.g., to the requestor entity and/or to a defined recipient) at 808.

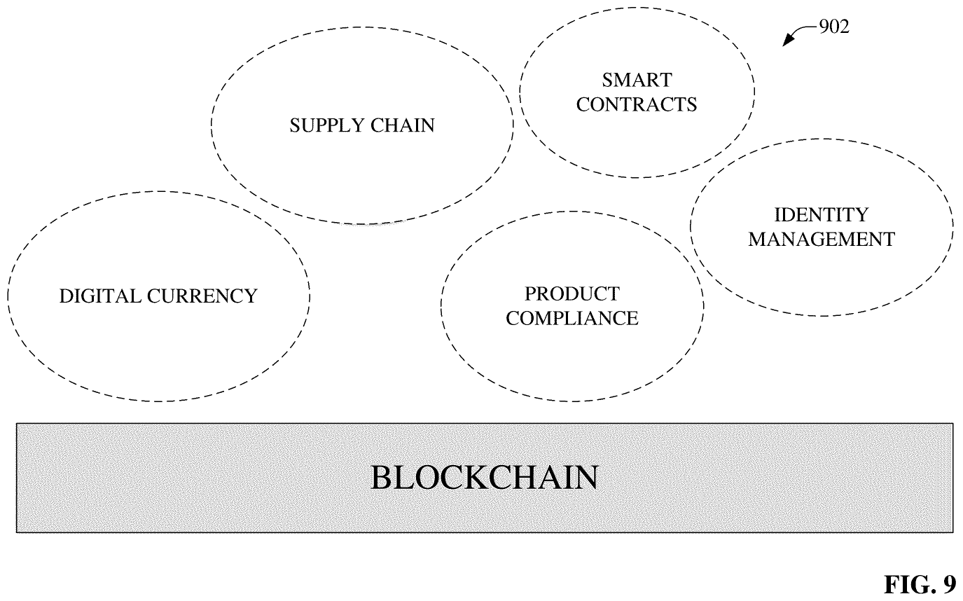

A general, high-level overview of blockchain technology is now provided as a background for the industrial-specific applications of blockchain technology discussed herein. FIG. 9 is a generalized high-level diagram illustrating the relationship between blockchain technology and applications 902 that can leverage blockchains. In general, blockchain is a foundational technology upon which applications can be built to leverage the technology. Digital currency such as Bitcoin is an example application that uses a public blockchain to act as a distributed ledger in a peer-to-peer network. Blockchain technology is also used to implement smart contracts, which allow a set of contractual rules to be programmed and enforced by a network of peer-to-peer devices without requiring a third-party mediator or broker. As discussed herein, one or more embodiments of the present disclosure can include industrial devices and applications that leverage blockchain technology to perform supply chain tracking, verify product compliance, perform identity management, monitor, and record information relating to local manufacturing operations within a single facility (e.g., within the bounds of the plant's intranet), or other such industrial functions.

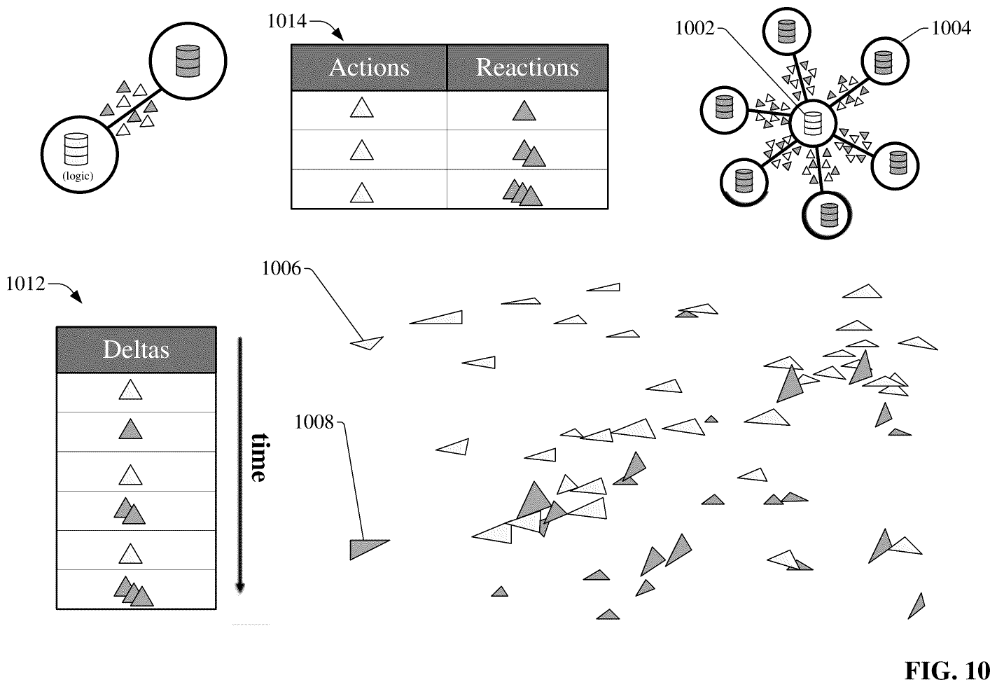

Blockchain-based platforms can provide access to data from multiple parties in a decentralized manner, in contrast to platforms that share data using a centralized model. FIG. 10 is a graphic illustrating a centralized model for accessing and modifying data. According to this centralized model, there is a single “golden copy” 1002 of the data being viewed and acted upon by one or more entities 1004 (e.g., systems running applications that leverage the data represented by the golden copy 1002, client devices operated by respective users, etc.). Any of the entities 1004 can copy data maintained on the golden copy 1002 as a whole or in part. This golden copy 1002 of the data model is updated by commanding state changes to the model (an example technique for communicating state changes of objects between components is described in U.S. Pat. No. 9,864,365, which is incorporated herein by reference). These state change instructions are referred to herein as “actions” 1006. Copies and views of the golden copy 1002 remain synchronized by observing changes to the golden copy 1002 of the model. These observed changes are referred to herein as “reactions” 1008. Table 1014 represents a set of actions performed on the data and corresponding observed reactions accumulated as a result of the actions. The collection of actions 1006 and reactions 1008 can be viewed as a set of changes or deltas 1010 ordered by time, as represented by table 1012. This set of deltas 1010 can be “played back” by any number of entities to obtain the same consistent data model, with the golden copy 1002 being the model that is trusted by everyone.

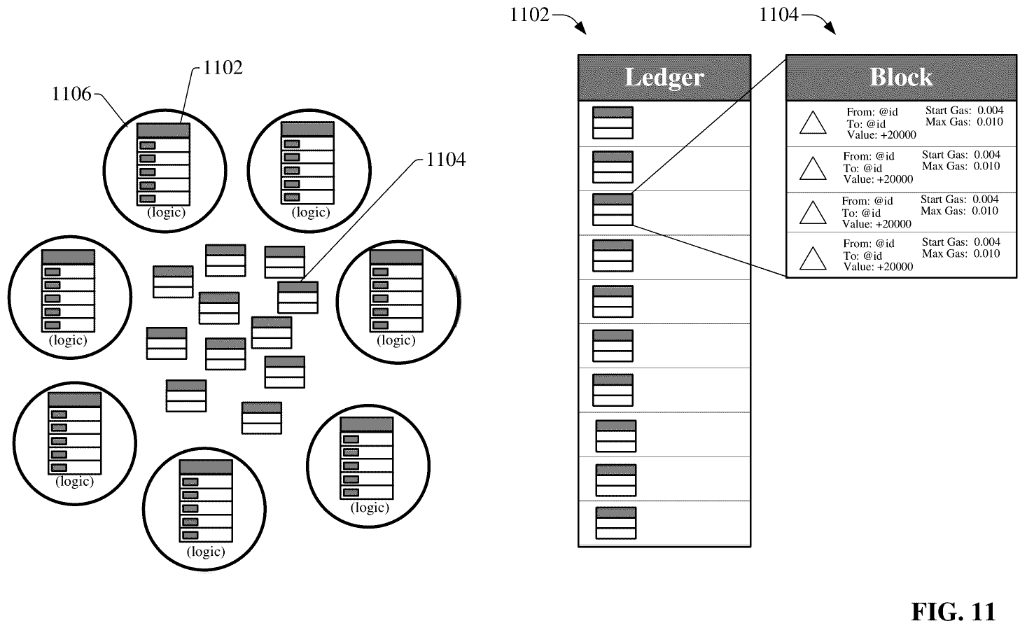

By contrast, blockchain-driven platforms decentralize the data model, eliminating the need to maintain a golden copy 1002 or distributing the multiple coordinated versions of the truth. FIG. 11 is a graphic illustrating a decentralized model. In a decentralized model, all entities 1106 that interact with the data have a copy of the data, and all entities work to keep the data model's transactions ordered and consistent. Blocks 1104 of changes to the data are recorded as a transaction. A distributed ledger 1102 of all these changes is maintained by all entities 1106 (or nodes or participants) that participate in the platform. If all entities 1106 apply the changes to their own copy of the data, then the copies remain consistent across the entities 1106 without the need for a single golden copy. Each entity maintains a copy of the ledger 1102, which represents a continuous chain of transaction blocks 1104, hence the term “blockchain.” When a transaction is performed on the data by one of the entities 1106, all entities 1106 process the transaction and determine the validity of the transaction. If a consensus among the entities 1106 is reached regarding the transaction's validity, each entity updates its copy of the ledger 1102 accordingly.

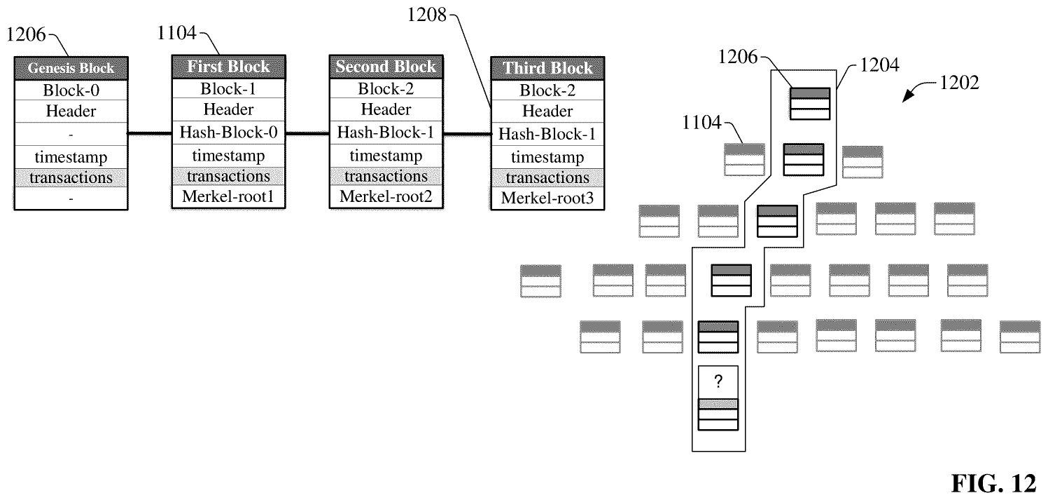

A blockchain consists of a data structure that orders blocks and links the blocks cryptographically, thereby acting as an immutable, verifiable, distributed ledger. Blockchains require no central authority; instead, trust is established and enforced cryptographically, with participating nodes (e.g., devices associated with entities 1106) acting as a consortium and voting on the validity of a block using a consensus mechanism to manage the distributed ledger. FIG. 12 is a graphic illustrating a blockchain architecture. Blockchains are a linked hierarchical list 1202 of transaction blocks 1104, where chains of related, linked transaction blocks 1104 within the hierarchy (e.g., chain 1204) stem from an initial genesis block 1206. Each block 1104 has a cryptographic identity, which is calculated by the header data 1208 in the block. Each block 1104 contains the hash of the previous block in the chain.

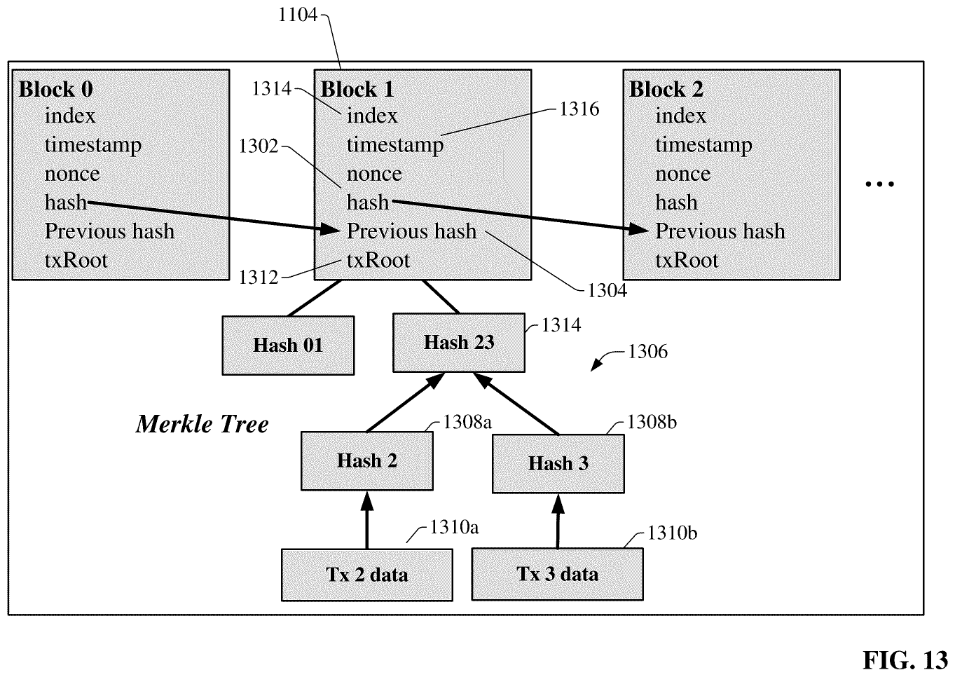

FIG. 13 is a diagram illustrating a general architecture of an example blockchain. Data 1310 associated with the block's transactions is hashed, and the collection of transaction data 1310 and their associated hashes 1308 create a Merkle tree 1306 of hashes 1308 (only two items of data 1310 are shown in FIG. 13 for clarity; however, a block 1104 can be associated with more than two transactions). In the illustrated example, each data item 1310a and 1310b is hashed to yield two corresponding hash values 1308a and 1308b. These two hashes 1308a and 1308b are combined into another hash value 1302 at the next higher level in the Merkle tree hierarchy. Hash values at a given level of the Merkle tree can be combined with other hash values on that level to yield hash values at the next higher level until the top of the Merkle tree hierarchy is reached.

The Merkle tree 1306 is stored separately from the block 1104, and only the root fingerprint 1312 (the top hash) is stored in the block 1104. Each block 1104 also contains a hash 1304 of the content of the immediately preceding block in the chain. For each block 1104, the Merkle tree of hashes 1308 and the hash 1304 of the previous block in the chain are used to create the hash 1302 for the block. The data 1310 is stored in the Merkle tree 1306 separately from the block 1104, with the root fingerprint 1312 being the only part of the Merkle tree 1306 stored in the block 1104. This nesting of cryptographic hash values yields a digital fingerprint that renders unauthorized tampering difficult. Compounded with the chaining of transaction blocks 1104, the blockchain becomes increasingly difficult to hack, producing a level of trustworthiness that increases over time. Improperly modifying a block 1104 would require tampering with the entire transaction history, rendering tampering nearly impossible. In this way, a verifiable, tamper-proof ledger of transactions can be efficiently maintained.

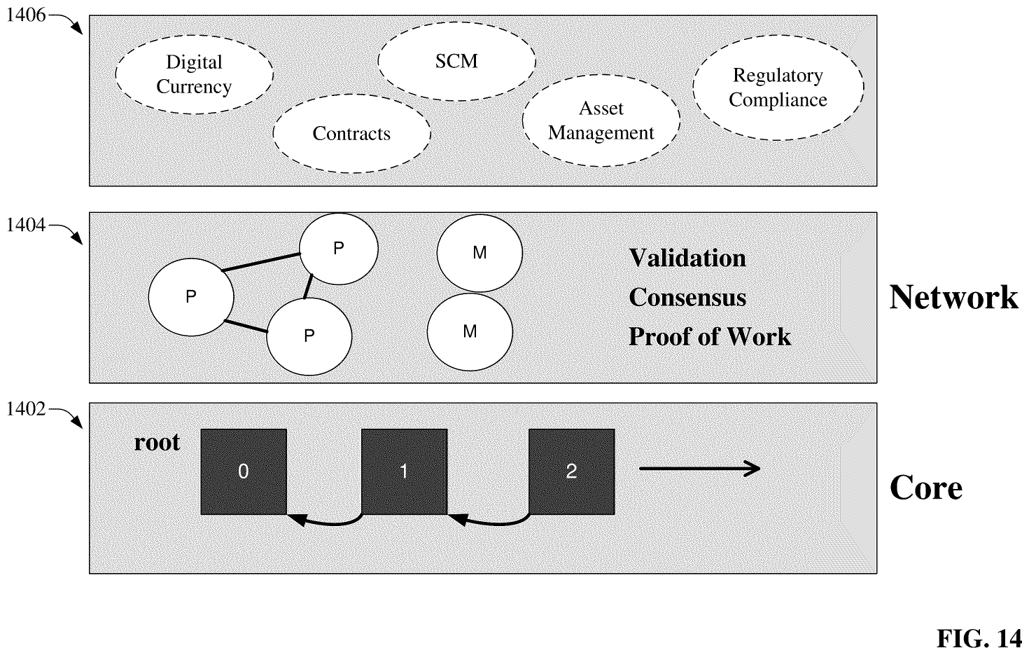

FIG. 14 is a diagram illustrating a generalized architecture of a blockchain platform. The core blockchain functionality 1402 (the blockchain creation and management features described above) is implemented on a network 1404 of participating devices or nodes. The core blockchain ledger is distributed throughout the network, and is independently validated by network members. In a public model, the network 1404 is purely peer-to-peer with no central trust authority. Instead of a central trust authority, network peers are responsible for validation and decentralized consensus for acceptance of new transactions (that is, new blocks 1104 representing new transactions) into the blockchain. Public blockchains are secured by the amount of work required to create a new block 1104. This proof-of-work model can prevent network peers from improperly hijacking or tampering with the blockchain. Private blockchain models—including blockchain applications used within an industrial facility as will be described herein—can employ a central authority to manage the ledger, user identities, and creation of new blocks.

Applications 1406 that employ blockchains are constructed on top of the network layer, which exposes the core blockchain functions. Participants in the network 1404 (the peer devices) are uniquely identified with digital signatures granted by the network. Participant identities may be anonymous depending on the type of blockchain network model (e.g., public, or private). In all cases, transactions are published, visible, and verifiable on the blockchain.

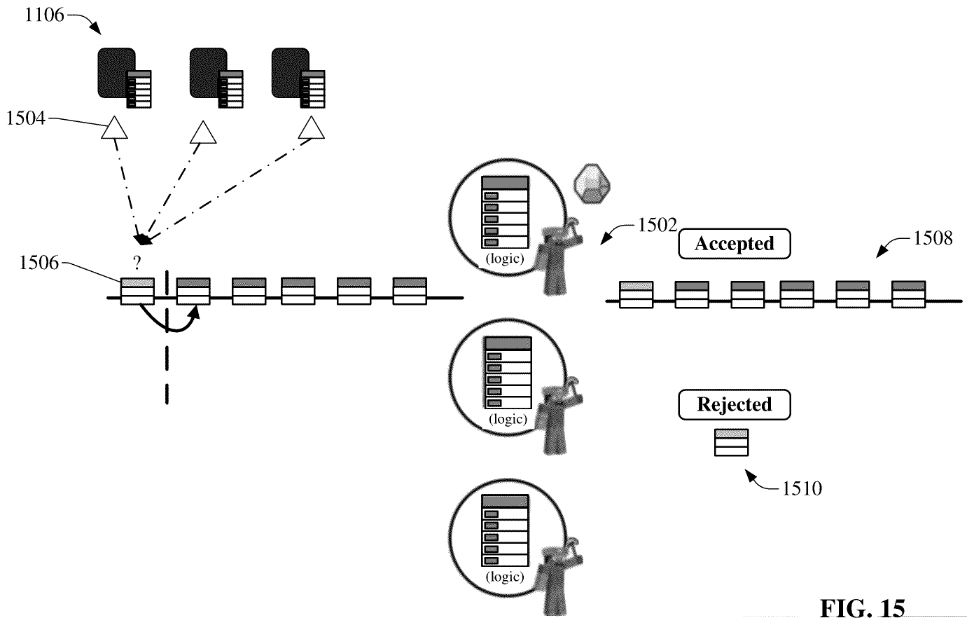

FIG. 15 is a generalized diagram illustrating creation of blocks and validation of blocks via consensus-based validation. Single transactions 1504 performed by entities 1106 (participants in the blockchain network) are gathered into blocks 1506 by programmatic components executing on the entities 1106 referred to as “miners” 1502. Miners 1502 possess the entire Merkle tree for the gathered transactions and compete to build a valid block out of the Merkle tree. The first miner 1502 to create a block is rewarded. The block is then validated by the other entities 1106 based on the hashes. If valid, the block is added to the blockchain 1508.

Since these blocks 1506 are created and validated in parallel, different versions of the truth can be generated. In these cases, the peers (entities 1106) vote on which block should be used. Regardless of the final set of blocks, all choices are most likely valid. The participants in the blockchain network can validate transactions and reject invalid or nefarious transactions 1510 (e.g., spending the same money twice in the case of digital currency applications). The system is ultimately consistent and valid.

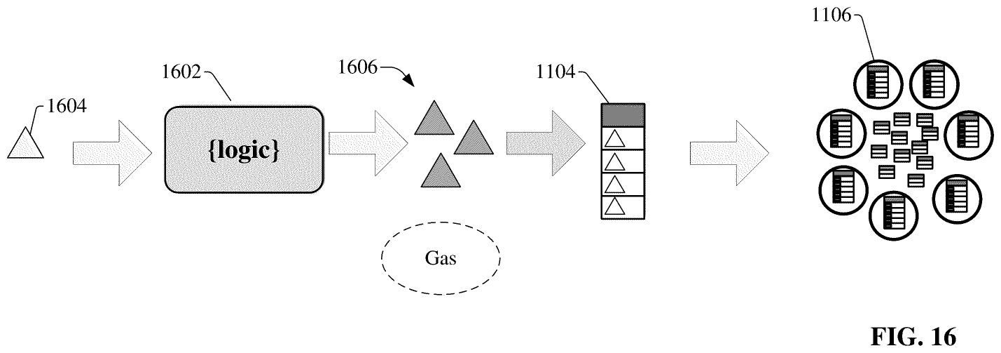

Some blockchain platforms are also capable of implementing and enforcing smart contracts, which define rules or agreements between participants in the blockchain network. FIG. 16 is a generalized diagram illustrating implementation of smart contracts within a blockchain-driven system. In general, smart contracts are sets of logic 1602 that execute on the blockchain and generate new types of transactions in accordance with rules defined by the logic. The smart contract logic 1602 is executed by the participants of the blockchain. When a smart contract transaction 1604 is generated, the logic 1602 executes on the transaction 1604 and can create several new transactions 1606 designed to satisfy the contract. On the Ethereum platform, units of processing “fees” must be provided by an initiator of a smart contract transaction in order to execute the transaction. On the Ethereum platform, these fees are referred to as Ether or “gas.” The amount of gas required to execute a transaction is generally proportional to the amount of work required to execute the transaction. The more complex the transaction, the more gas must be spent to execute the transaction. These processing “fees” can be used to prioritize transactions based on relative values of the transactions, and can also protect against Denial of Service attacks (e.g., attacks that place the contract's logic in an infinite loop). Work on selected transactions can be prioritized by assigning extra gas to the transactions.

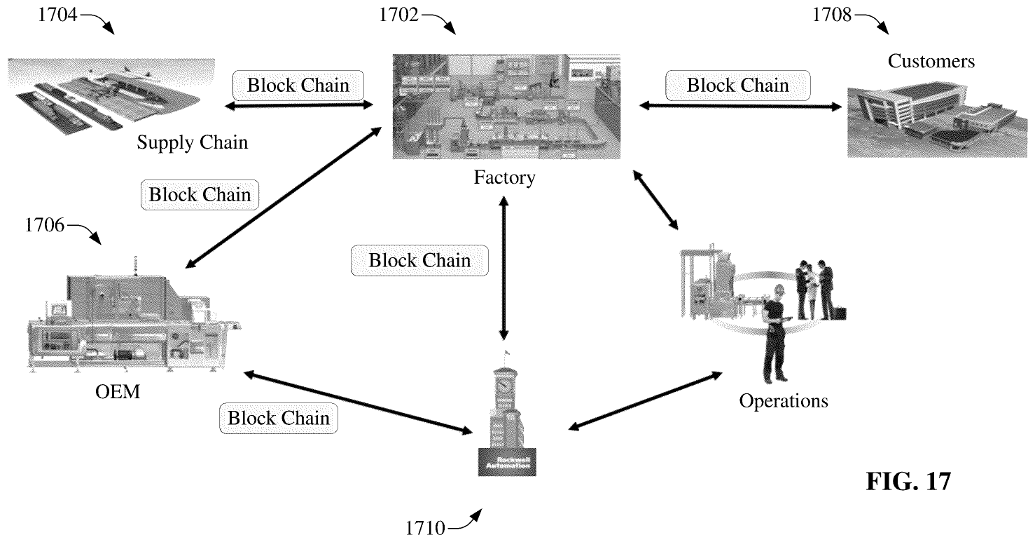

Various embodiments described herein leverage aspects of blockchain platforms within the context of industrial facilities, industrial enterprises, and manufacturing and distribution supply chains. To this end, industrial devices such as industrial controllers, motor drives, data historians, telemetry devices, HMIs, and other such industrial devices are configured to support creation, validation, and sharing of blockchains. FIG. 17 is a high-level overview of entities and enterprises within an industrial supply and distribution chain within which industrial-specific blockchains can be utilized. In general, blockchain-enabled industrial devices can utilize blockchain technology in connection with such tasks as asset and product lifecycle management within a factory 1702; device, machine, line, or factory configuration integrity tracking; regulatory compliance verification; auditing of lock out/tag out safety procedures within the factory 1702; customer/partner entitlements management, management and tracking of supply chains 1704 across enterprise boundaries; inventory management across a supply chain; contracts management; tracking of manufactured products across enterprises of a supply chain or within a factory 1702; or other applications to be discussed herein.

The use of blockchains between industrial enterprises can also open the possibility of subscription-based serves between OEMs 1706 and owners of factories 1702, or between a manufacturing entity and its customers. Blockchains can also be used to track manufactured products to the end consumers 1708, and public blockchain data generated by a product's traversal through the manufacturing and supply chain can be accessed by consumers 1708 to obtain information about their purchased products. A device vendor 1710 can manufacture and provide blockchain-enabled industrial devices that are used within industrial factories 1702, OEM facilities 1706, and other enterprises to facilitate blockchain-driven industrial applications. The device vendor 1710 can also act as a trust authority for blockchain-driven systems that are implemented by the blockchain-enabled industrial devices. Robust identity management for organizations, people, and products that participate in an industrial blockchain system can ensure the trustworthiness of the participants and the blockchain data. Both public and private blockchain models can be implemented depending on the needs of the industrial application using the platform.

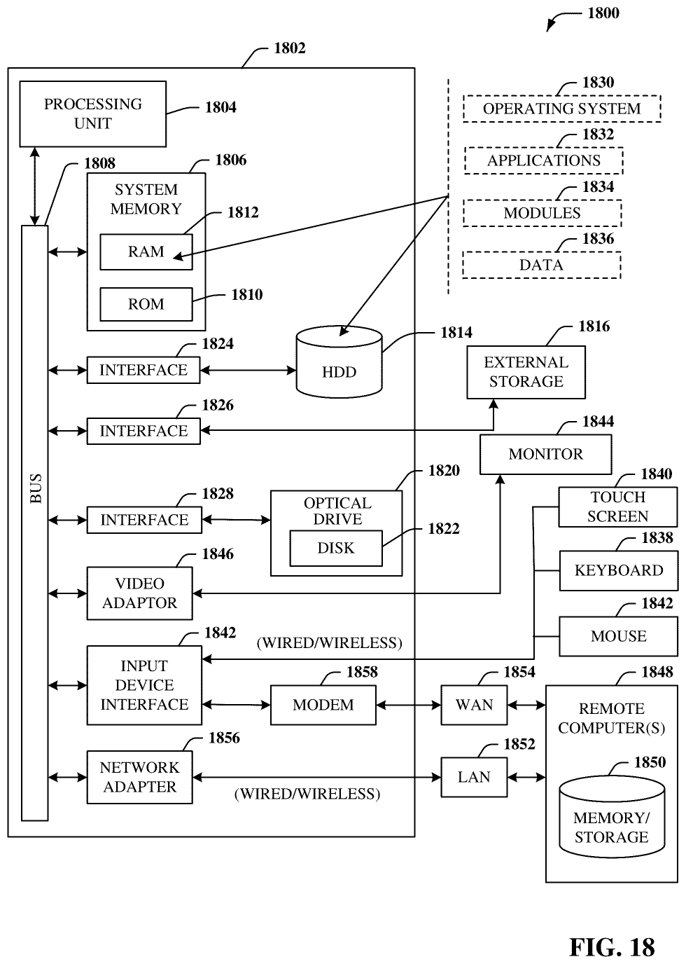

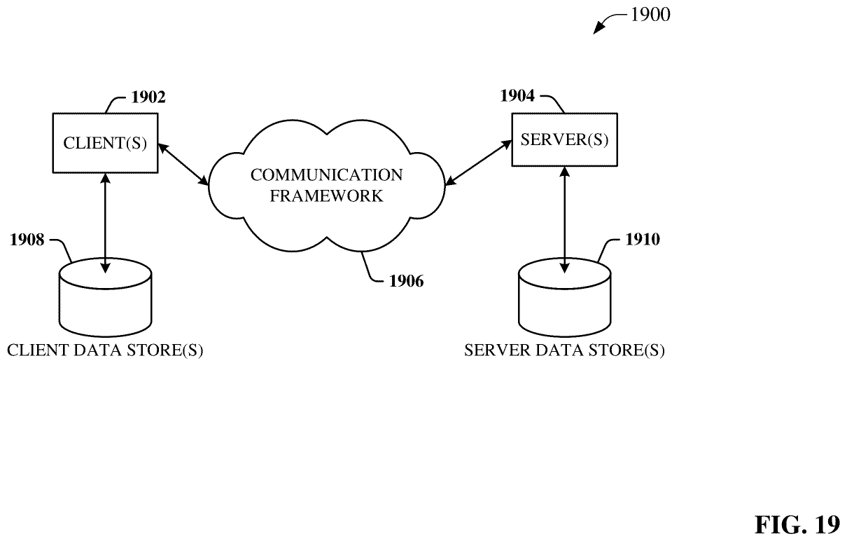

In order to provide a context for the various aspects of the disclosed subject matter, FIGS. 18 and 19 as well as the following discussion are intended to provide a brief, general description of a suitable environment in which the various aspects of the disclosed subject matter can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for application programs 1832. Runtime environments are consistent execution environments that allow application programs 1832 to run on any operating system that includes the runtime environment. Similarly, operating system 1830 can support containers, and application programs 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance, with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1844 or other type of display device can be also connected to the system bus 1808 via an interface, such as a video adapter 1846. In addition to the monitor 1844, a computer typically includes other peripheral output devices (not shown), such as speakers, printers, etc.

The computer 1802 can operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1852 through a wired and/or wireless communication network interface or adapter 1856. The adapter 1856 can facilitate wired or wireless communication to the LAN 1852, which can also include a wireless access point (AP) disposed thereon for communicating with the adapter 1856 in a wireless mode.

When used in a WAN networking environment, the computer 1802 can include a modem 1858 or can be connected to a communications server on the WAN 1854 via other means for establishing communications over the WAN 1854, such as by way of the Internet. The modem 1858, which can be internal or external and a wired or wireless device, can be connected to the system bus 1808 via the input device interface 1842. In a networked environment, program modules depicted relative to the computer 1802 or portions thereof, can be stored in the remote memory/storage device 1850. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1852 or WAN 1854 e.g., by the adapter 1856 or modem 1858, respectively. Upon connecting the computer 1802 to an associated cloud storage system, the external storage interface 1826 can, with the aid of the adapter 1856 and/or modem 1858, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 19 is a schematic block diagram of a sample computing environment 1900 with which the disclosed subject matter can interact. The sample computing environment 1900 includes one or more client(s) 1902. The client(s) 1902 can be hardware and/or software (e.g., threads, processes, computing devices). The sample computing environment 1900 also includes one or more server(s) 1904. The server(s) 1904 can also be hardware and/or software (e.g., threads, processes, computing devices). The servers 1904 can house threads to perform transformations by employing one or more embodiments as described herein, for example. One possible communication between a client 1902 and servers 1904 can be in the form of a data packet adapted to be transmitted between two or more computer processes. The sample computing environment 1900 includes a communication framework 1906 that can be employed to facilitate communications between the client(s) 1902 and the server(s) 1904. The client(s) 1902 are operably connected to one or more client data store(s) 1908 that can be employed to store information local to the client(s) 1902. Similarly, the server(s) 1904 are operably connected to one or more server data store(s) 1910 that can be employed to store information local to the servers 1904.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. An industrial system, comprising:
a memory that stores executable components; and
a processor, operatively coupled to the memory, that executes the executable components, the executable components comprising:
a minting component that mints a non-fungible token associated with a product generated using industrial automation equipment, wherein the non-fungible token comprises a first verification element; and
a verification component that:
verifies the product based on a comparison of a first aspect of the product to the first verification element, and
generates an output representative of the comparison.

2. The industrial system of claim 1, wherein the non-fungible token further comprises a second verification element, wherein the comparison further comprises comparing, by the verification component, a second aspect of the product to the second verification element, and wherein the first verification element is different from the second verification element.

3. The industrial system of claim 2, wherein the first verification element comprises a label unique to the product.

4. The industrial system of claim 2, wherein the second verification element comprises a position of the label on the product.

5. The industrial system of claim 2, wherein the second verification element comprises a time that the label was applied to the product or a time at which the product was manufactured.

6. The industrial system of claim 2, wherein the executable components further comprise:
a firmware component that installs a firmware update to the product in response to the comparison resulting in a match of the first aspect of the product to the first verification element and the second aspect of the product to the second verification element.

7. The industrial system of claim 2, wherein the executable components further comprise:
a firmware component that blocks installation of a firmware update to the product in response to the comparison resulting in a non-match of the first aspect of the product to the first verification element or a non-match of the second aspect of the product to the second verification element.

8. The industrial system of claim 1, wherein the executable components further comprise:
a blockchain component that stores the non-fungible token to an industrial blockchain.

9. The industrial system of claim 1, wherein the non-fungible token represents a bill of materials of the product.

10. The industrial system of claim 1, wherein the non-fungible token comprises a group of non-fungible sub-tokens.

11. The industrial system of claim 10, wherein a non-fungible sub-token of the group of non-fungible sub-tokens is minted, by the minting component, for a component of the product.

12. A method, comprising:
prior to a disablement of an industrial automation device, determining, by an industrial automation system comprising a processor, configuration data representative of a configuration of the industrial automation device;
storing, by the industrial automation system, a hash of the configuration data to an industrial blockchain;
in response to an enablement of the industrial automation device, subsequent to the disablement, determining, by the industrial automation system, whether current configuration data representative of a current configuration of the industrial automation device matches the configuration data; and
generating, by the industrial automation system, an output indicative of whether the current configuration data representative of a current configuration of the industrial automation device matches the configuration data.

13. The method of claim 12, wherein the configuration of the industrial automation device comprises a position of the industrial automation device prior to the disablement.

14. The method of claim 12, further comprising:
prior to determining whether current configuration data matches the configuration data, retrieving, by the industrial automation system, the configuration data from the industrial blockchain.

15. The method of claim 12, further comprising:
in response to a determination that the current configuration data does not match the configuration data, disabling, by the industrial automation system, the industrial automation device.

16. The method of claim 12, wherein the configuration data comprise a joint test action group identifier applicable to the industrial automation device.

17. A non-transitory computer-readable medium having stored thereon instructions that, in response to execution, cause an industrial device comprising a processor to perform operations, the operations comprising:
writing, to an industrial blockchain, data representative of installation of a component in a product generated using industrial automation equipment;
in response to receiving a verification request comprising data representative of components currently installed in the product, determining whether the component has been removed from the product based on a comparison of the components currently installed in the product with the component; and
sending data representative of a result of the verification request.

18. The non-transitory computer-readable medium of claim 17, wherein the data representative of the installation of the component is generated using a defined hashing algorithm.

19. The non-transitory computer-readable medium of claim 17, wherein the industrial blockchain comprises a private industrial blockchain.

20. The non-transitory computer-readable medium of claim 17, wherein the industrial blockchain comprises a public industrial blockchain.
